(19) United States
(12) Patent Application Publication
(10) Pub. No.: US 2024/0280354 A1
(43) Pub. Date: Aug. 22, 2024

(54) SUPPORT FOR DISTANCE MEASUREMENT DEVICE

(71) Applicant: The Stanley Works Israel Ltd., Rosh Ha'Ayin (IL)

(72) Inventors: Amit RAN, Mazkeret Batia (IL); Ohad WAISSENGREEN, Emek Sorek (IL); David RIESENBERG, Rehovot (IL)

(73) Assignee: The Stanley Works Israel Ltd., Rosh Ha'Ayin (IL)

(21) Appl. No.: 18/640,948

(22) Filed: Apr. 19, 2024

Related U.S. Application Data
(63) Continuation of application No. PCT/EP2022/079025, filed on Oct. 19, 2022.

(30) Foreign Application Priority Data
Oct. 25, 2021 (GB) 2115331.7

(51) Int. Cl. G01B 3/12; A45F 5/02; G01B 5/00

(52) U.S. Cl. CPC G01B 3/12; G01B 5/0004; A45F 5/021

(57) ABSTRACT

A support for supporting a distance measurement device on a tool, includes a main body and an adjustment part. The main body includes an attachment part for removably attaching the support to a tool. The adjustment part is attached to the main body and includes a mount for removably mounting a distance measurement device thereto. The mount is movable with respect to the main body to adjust a position of the distance measurement device with respect to the main body. The distance measurement device may comprise a distance measuring roller configured for measuring distances along surfaces by rolling contact therewith. The distance measurement device may be removably attachable to a tool by means of the support, for measuring distances on a workpiece worked on by the tool.

### CROSS REFERENCE TO RELATED APPLICATIONS

This application is a continuation of International Patent Application No. PCT/EP2022/079025 filed Oct. 19, 2022, which claims benefit and priority to GB Application No. 2115331.7 filed Oct. 25, 2021. The entire contents of each are incorporated herein by reference.

### BACKGROUND

The present disclosure relates to a support for a distance measurement device, to a kit of parts comprising the support and the distance measurement device, and to a distance measurement device suitable for attachment to a support. The distance measurement device may comprise a distance measuring roller configured for measuring distances along surfaces by rolling contact therewith. The distance measurement device may be removably attachable to a tool by means of the support, for measuring distances on a workpiece worked on by the tool, for example.

### SUMMARY

Example embodiments of the present application may relate to improving the speed and/or accuracy and/or convenience of making distance measurements for working on a workpiece with a tool. The tool may comprise a power tool, especially a saw, a drill, a router, or the like, but at least in the broadest aspects or uses of the invention, the tool may comprise a (non-powered) hand tool, e.g. a utility knife. The tool may comprise a chop saw, a mitre saw, a circular saw, a table saw, a band saw, a jigsaw, a track saw, a drill press, etc. The invention seeks to facilitate the speedy and accurate cutting, drilling, or other tool operation, on a workpiece at the correct position(s) and/or for the correct lengths/distances, etc., prior to and/or during the operation of the tool on the workpiece.

A first aspect of the invention provides a support for supporting a distance measurement device on a tool.

A second aspect of the invention provides a kit of parts.

A third aspect of the invention provides a handheld distance measurement tool.

A first aspect of an example embodiment provides a support for supporting a distance measurement device on a tool, comprising: a main body including an attachment part for removably attaching the support to a tool; and an adjustment part attached to the main body and including a mount for removably mounting a distance measurement device thereto; wherein the mount is movable with respect to the main body to adjust a position of the distance measurement device with respect to the main body, in use.

Advantageously, the mount may be movable with respect to the main body to adjust a position of the distance measurement device with respect to a workpiece on which the tool will be operated, or is being operated, in use.

In embodiments of the invention, the adjustment part is movable with respect to the main body to adjust a position of the mount, and therefore a position of the distance measurement device, with respect to the main body, in use. The adjustment part is slidably attached to the main body. The adjustment part may be movable with respect to the main body by means of a ratchet mechanism or a rack-and-pinion mechanism, for example, but other movement mechanisms are possible. For example, the adjustment part may be slidable with respect to the main body and securable at any particular position by means of at least one screw-threaded tightening/release member and/or latch and/or detent, etc.

Where present, the ratchet mechanism for adjusting the position of the adjustment part may comprise a series of ratchet teeth arranged on the adjustment part and advantageously may include a movable locking member supported by the main body. The locking member (where present) may be resiliently biased, e.g. by means of a spring or other resilient member (e.g. an elastomeric part), to engage with the ratchet teeth of the adjustment part. The ratchet mechanism includes a user-actuatable release member, and may be supported on the main body, configured to selectively allow substantially free movement of the adjustment part with respect to the main body. Actuation of the release member may force the locking member away from the ratchet teeth against the resilient bias, to allow the substantially free movement of the adjustment part.

The adjustment part may be settable at any of a plurality of positions on the main body, e.g. to accommodate any of a plurality of different dimensions of workpiece worked on by the tool, in use. The adjustment part may be settable at multiple such positions, and may be settable at twenty or more such positions, e.g. thirty or more such positions. In some embodiments, the adjustment part is settable at substantially any position within a range of positions with respect to the main body, e.g. to accommodate substantially any dimension of workpiece that can be worked on by the tool. That is, in some embodiments of the invention, the adjustment part may be “infinitely adjustable” within a predetermined range of positions.

The adjustment part may be elongate. The mount may be located substantially at a longitudinal end region of the elongate adjustment part, e.g. so that extension of the adjustment part from the main body (so that the mount is spaced from the main body), and retraction of the adjustment part towards the main body (e.g. so that the mount is adjacent to the main body), may accommodate a relatively large range of dimensions of workpieces.

In embodiments, the mount is movable with respect to the adjustment part to adjust a position of the distance measurement device with respect to the main body, in use. The mount may be movable with respect to the adjustment part to adjust a position of the distance measurement device with respect to a workpiece on which the tool will be operated, or is being operated, in use.

The mount may be resiliently movable with respect to the adjustment part, e.g. to accommodate dimensional variations of a workpiece on which the tool will be operated, or is being operated, in use. A resilient device or member, e.g. a spring, may be located between the mount and the adjustment part, to provide the resilient movability of the mount with respect to the adjustment part. The mount may be configured to be resiliently biased towards a tool to which the support is attached, in use. The arrangement may be such that the mount is configured to be resiliently biased towards a workpiece on which the tool will be operated, or is being operated, in use.

The mount of the support may comprise a connector, especially a bayonet-fitment connector, e.g. for ease and speed of connection and disconnection of the distance measurement device.

The attachment part may comprise a clamp member or the like, e.g. a screw-threaded clamp member and/or an over-centre latch clamp member and/or a trigger clamp member. Advantageously, the attachment part may be configured to attach the support to a housing or guard or fence of the tool, e.g. a fence of a mitre saw, table saw, band saw, or other saw fence.

As indicated above, a second aspect provides a kit of parts comprising a support according to the invention, and a distance measurement device configured for removable mounting to the mount of the support.

The distance measurement device may include a corresponding connector configured for removable connection with a connector on the mount. The distance measurement device may include a corresponding bayonet-fitment connector configured for removable connection with a bayonet-fitment connector of the mount. Advantageously, at least one of the bayonet-fitment connectors (e.g. the connector carried by the distance measurement device) may include one or more resiliently-biased detent parts configured to assist in maintaining the connection with the other bayonet-fitment connector (until disconnection is required), in use.

In embodiments, the distance measurement device is configured for selective use: (i) mounted to the support; and (ii) as a handheld distance measurement tool disconnected from the support.

The distance measurement device may include: a housing; and a distance measuring roller mounted partly in the housing and extending partly therefrom, and configured for measuring distances along surfaces by rolling contact therewith. The distance measurement device may further include a display mounted on the housing and configured for displaying distances measured by the roller in use.

As also indicated above, a third aspect of the invention provides a handheld distance measurement tool, comprising: a housing; a distance measuring roller mounted partly in the housing and extending partly therefrom, and configured for measuring distances along surfaces by rolling contact therewith; a display mounted on the housing and configured for displaying distances measured by the roller in use; and a connector, which may be a bayonet-fitment connector, located in and/or on the housing.

The connector (for example, a bayonet-fitment connector) may be for removably connecting the handheld distance measurement tool with a separate support having a corresponding connector (for example, bayonet-fitment connector).

The handheld distance measurement tool may further comprise a said separate support. The separate support may comprise a belt clip, or other clip, configured for removable attachment of the tool to the belt of a user, or to other external objects.

### BRIEF DESCRIPTION OF THE DRAWINGS

Embodiments and implementations will now be described, by way of example, with reference to the accompanying figures, of which:

FIG. 1 (views (a) and (b)) shows a distance measurement device in accordance with an example embodiment;

FIG. 2 (views (a) and (b)) shows two additional views of the distance measurement device in accordance with an example embodiment;

FIG. 3 (views (a) and (b)) shows two partially internal schematic views of the distance measurement device in accordance with an example embodiment;

FIG. 4 (views (a) to (d)) shows four views of a support in accordance with an example embodiment;

FIG. 5 shows a view of an assembled kit of parts in accordance with an example embodiment, comprising the support and the distance measurement device mounted thereon;

FIG. 6 (views (a) and (b)) shows two further views of the support in accordance with an example embodiment;

FIG. 7 (views (a) and (b)) shows two views of the support in accordance with an example embodiment attached to a mitre saw fence;

FIG. 8 (views (a) and (b)) shows two additional views of the support in accordance with an example embodiment attached to a mitre saw fence;

FIG. 9 (views (a) to (c)) shows three views of the support in accordance with an example embodiment attached to a mitre saw fence and adjusted for different sizes of workpiece;

FIG. 10 (a) shows a cross-sectional view of the support in accordance with an example embodiment and FIG. 10 (b) shows a detail thereof;

FIG. 11 (views (a) and (b)) shows two cross-sectional detail views of the support in accordance with an example embodiment;

FIG. 12 shows another view of the support in accordance with an example embodiment;

FIG. 13 (views (a) to (c)) shows three views of a distance measurement device according to an example embodiment being mounted on a support according to the invention;

FIG. 14 (a) and FIG. 14 (b) show two cross-sectional partial views of the distance measurement device according to an example embodiment mounted on the support according to an example embodiment, and FIG. 14 (c) shows a partially internal view of the distance measurement device according to an example embodiment;

FIG. 15 shows another view of the distance measurement device according to an example embodiment; and

FIG. 16 (views (a) and (b)) shows two views of a support in accordance with an example embodiment, in the form of a belt clip.

### DETAILED DESCRIPTION OF EXEMPLARY EMBODIMENTS

In the figures and the following description, the same, or functionally the same or similar, features share the same reference numerals, for simplicity.

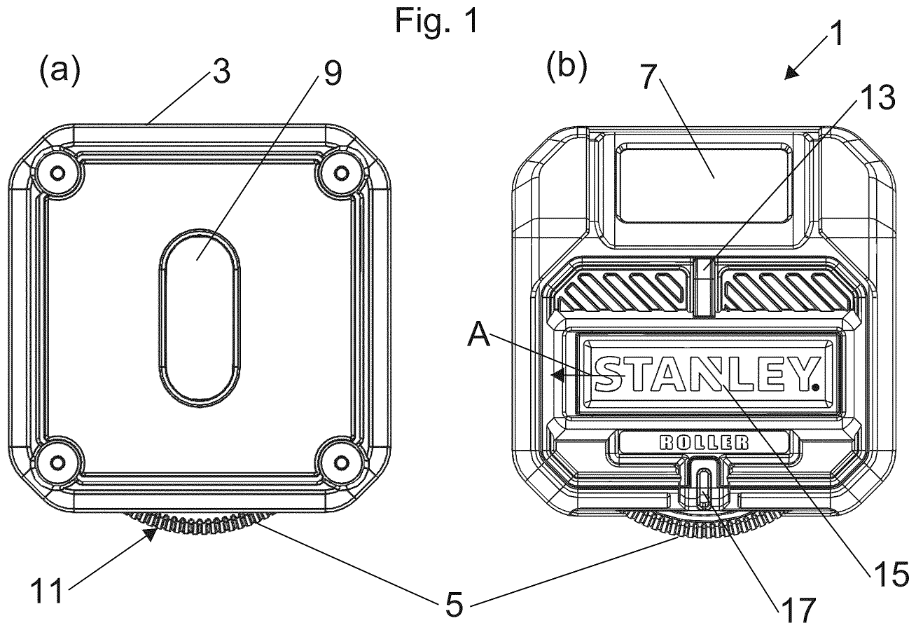

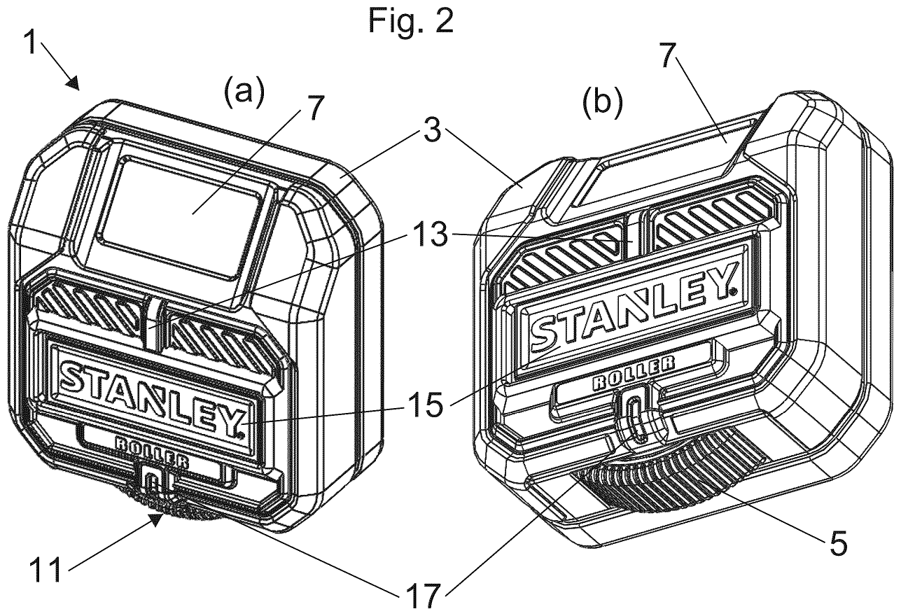

FIG. 1 (views (a) and (b)) and FIG. 2 (views (a) and (b)) show various views of an example embodiment of a distance measurement device. The distance measurement device 1 comprises a handheld distance measurement tool comprising a housing 3, a distance measuring roller 5 mounted partly in the housing 3 and extending partly therefrom, a display 7 mounted on the housing 3 and configured for displaying distances measured by the roller in use, and a (female) bayonet-fitment connector 9 located in and on the housing 3. The distance measuring roller 5 is configured for measuring distances along surfaces by rolling contact therewith, and is in the form of a wheel rotatably mounted in the housing, with an elastomeric circumferential region 11 to prevent the wheel from slipping on surfaces with which it is placed in contact, in use.

As also shown in FIGS. 1 (b), 2 (a) and 2 (b), the housing 3 of the distance measurement device 1 carries a settings button 13, an actuation button 15, and a laser or LED measurement marker light 17. When the user presses and holds (pressed) the actuation button 15, the distance measurement device 1 is activated and the display starts displaying distance measurements, and when the user releases the actuation button 15 the distance measurement device 1 turns off. This functionality is for manual handheld use of the distance measurement device 1 as a distance measurement tool, so that the user can “zero” the measurements and can control exactly what distances and lengths are measured. Alternatively, the user may press the actuation button 15 and slide the button to one side (left, as illustrated) as indicated by the arrow A in FIG. 1 (b). The actuation button 15 and housing 3 are configured to lock the actuation button in the “on” state when slid by the user I this way. This functionality is for use of the distance measurement device 1 when mounted on a tool, e.g. by means of the support.

The settings button 13 enables the user to select any of a variety of features and/or use modes of the distance measurement device 1, e.g. by sequential pressing of the settings button, with the features and/or modes indicated to the user by the display and/or by sound indication. For example, the user may be able to press the settings button 13 to carry out one or more of the following actions: save a measurement; scroll through features and/or modes of the device and/or saved measurements; change/set measurement units; change/set measurement tolerance; change/set display language; change/set sound (audio) indications; change/set wireless connectivity, e.g. Bluetooth™; change/set display screen luminance; change/set sleep mode timer; switch on/off the laser/LED marker light, or set it to energy-saving mode.

The laser or LED measurement marker light 17 is arranged to assist the user to align the distance measurement device 1 and/or a workpiece for making accurate distance/length measurements, in use.

Advantageously the distance measurement device 1 may include at least one wireless transceiver (e.g. a Bluetooth™ transceiver) to wirelessly connect the device 1 to one or more external devices for measurement display and/or control of the device 1.

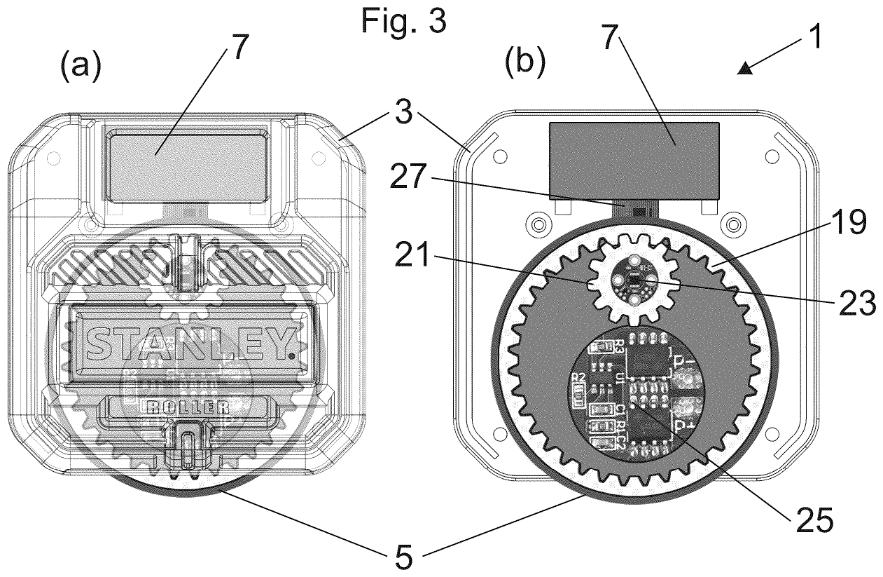

FIG. 3 (a) and FIG. 3 (b) show partially internal schematic views of the distance measurement device 1 of an example embodiment. The distance measuring roller 5 includes a substantially circumferential internal ring gear 19 which meshes with a rotary spur gear 21 located within the ring gear 19. A rotary encoder 23, e.g. a magnetic encoder, and/or an optical encoder, and/or a mechanical encoder, and/or an electronic encoder (e.g. resistive and/or capacitive), is also located in the housing 3, e.g. (as shown) located within the spur gear 21. The rotary encoder 23 is configured to sense the degree of rotation of the distance measuring roller 5 and, as part of a distance measurement system of the distance measurement device 1, to determine measured distances/lengths. For example, the distance measuring roller 5 may carry one or more magnets configured to be sensed by a magnetic encoder, and/or one or more mirrors to reflect the light beam of an optical encoder, as the distance measuring roller 5 rotates, in use. Other types of rotary encoder use other types of sensing arrangements, as known and understood by the skilled person. The distance measurement system includes electronics 25 (indicated schematically) located within the housing 3 of the distance measurement device 1, e.g. in the form of one or more circuit boards and/or microprocessors, and is electrically connected to the display 7 of the distance measurement device 1 by conductors (e.g. ribbon cable) 27. As is understood by the skilled person, the rotary encoder 23 senses the degree of rotation of the distance measuring roller 5 as the roller rotates during use, and the distance measurement system converts this into measured distances/lengths for display to the user by the display 7.

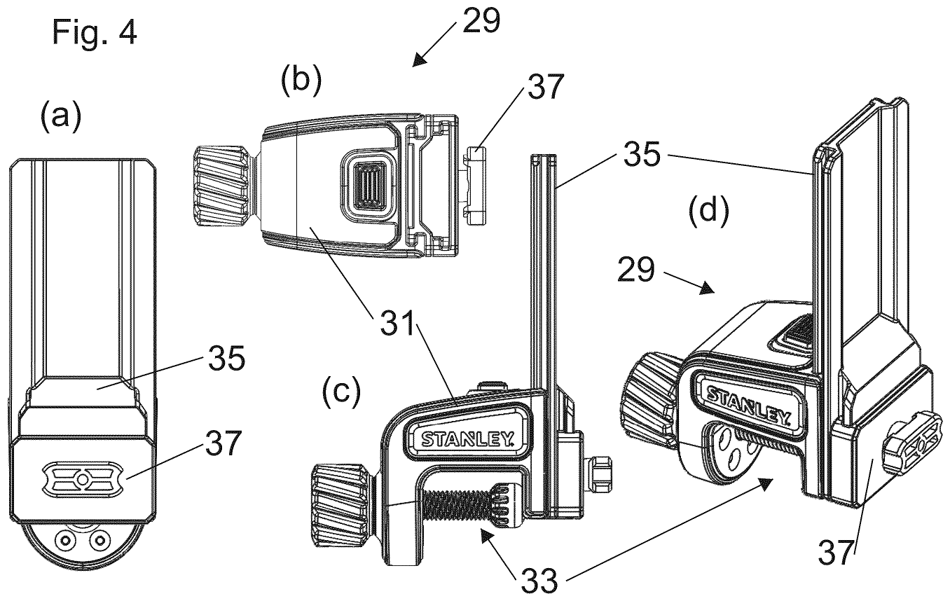

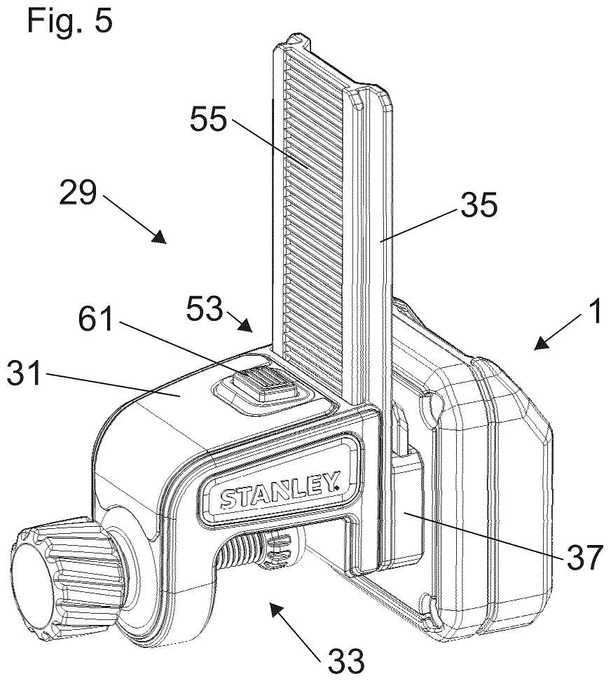

FIG. 4 (views (a) to (d)) shows four views of a support 29 for supporting a distance measurement device 1 on a tool, in accordance with the example embodiment. The support 29 comprises a main body 31 which includes an attachment part 33 for removably attaching the support 29 to a tool. An adjustment part 35 is attached to the main body 31 and includes a mount 37 for removably mounting a distance measurement device 1 to the adjustment part 35 of the support 29. FIG. 5 shows a view of a distance measurement device 1 mounted on the support 29.

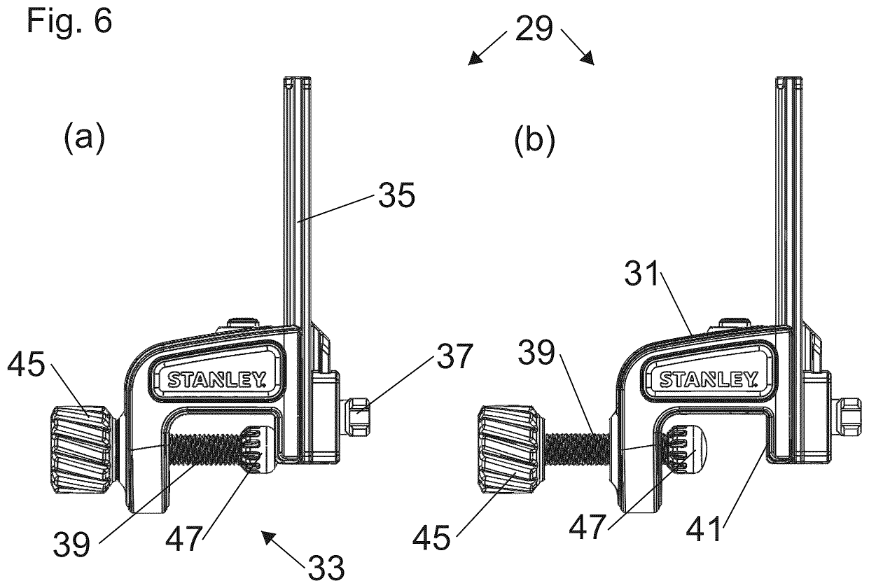

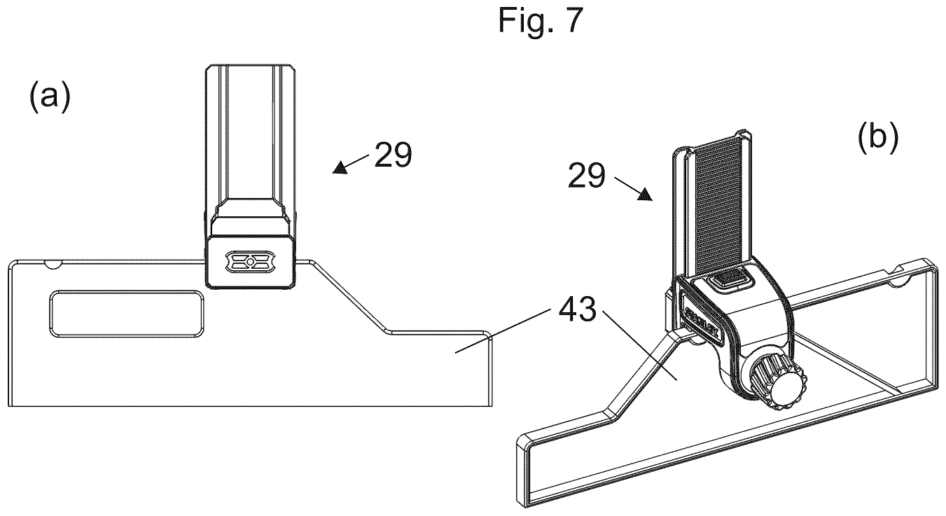

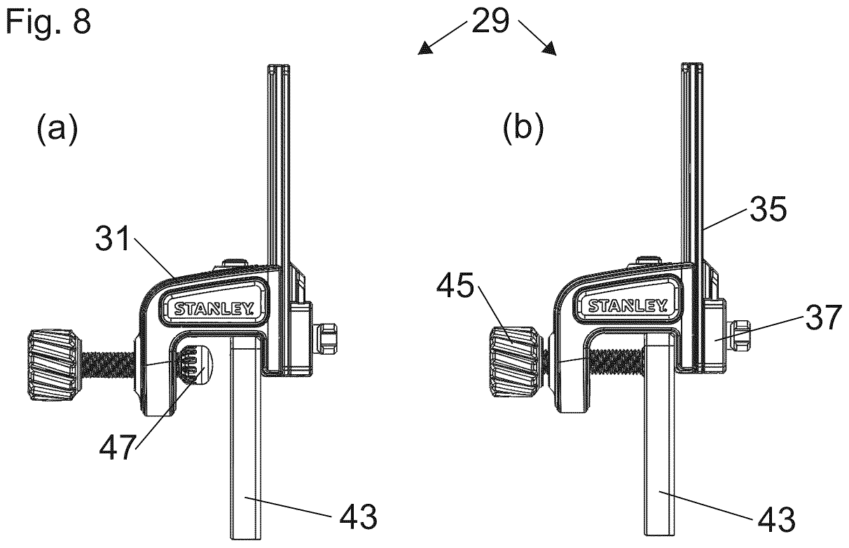

The various views of FIGS. 6, 7 and 8 illustrate the construction and functioning of the attachment part 33 of the support 29. The attachment part 33 comprises a clamp member 39 in the form of a movable screw-threaded clamp member, which is configured to attach the support 29 to a tool by clamping a part of the tool between the movable screw-threaded clamp member 39 and a stationary clamp member 41 (stationary clamp jaw). As illustrated in the views of FIGS. 7 and 8, the attachment part 33 may be configured to removably attach the support 29 to a fence 43 of a saw (e.g. a mitre saw, a table saw, a band saw, etc.). For other uses, the attachment part 33 may attach the support 29 to a housing or guard or mount of a tool, for example. The screw-threaded clamp member 39 includes a tightening/untightening knob 45 and a movable clamp jaw part 47 at the opposite end thereof.

The mount 37 of the support 29 is movable with respect to the main body 31 to adjust a position of the distance measurement device 1 (when mounted to the adjustment part 35) with respect to the main body, in use. More particularly, the mount 37 is movable with respect to the main body 31 to adjust a position of the distance measurement device 1 with respect to a workpiece on which a tool (to which the support is attached, in use) operates. To this end, the adjustment part 35 is movable with respect to the main body 31 to adjust a position of the mount 37 (and therefore to adjust a position of the distance measurement device 1), with respect to the main body 31, in use.

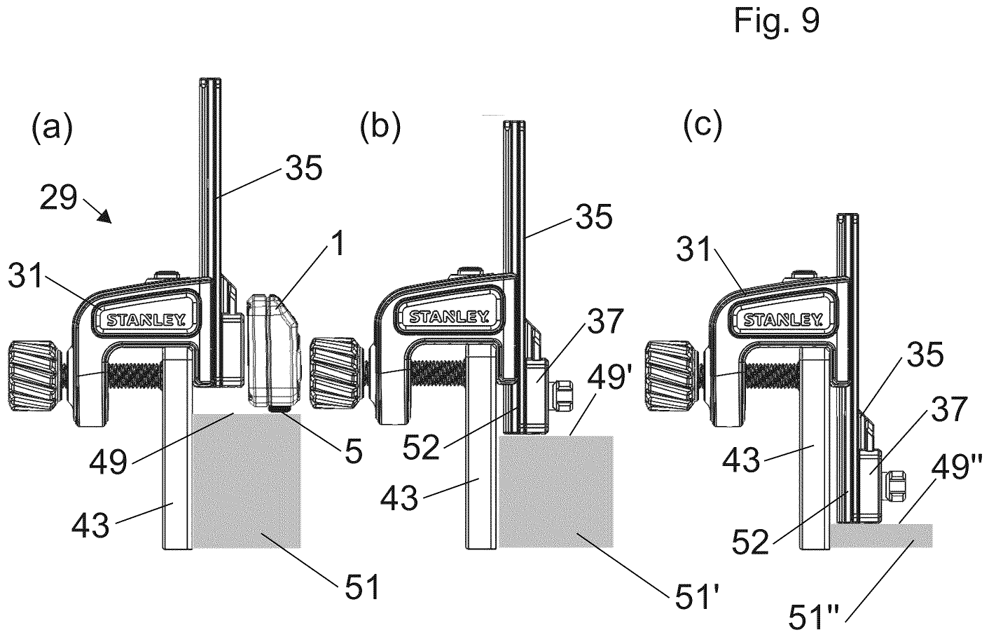

Advantageously, as illustrated in the sequence of three views (a), (b) and (c) of FIG. 9, the adjustment part 35 is slidably attached to the main body 31, e.g. while the support 29 is attached to the fence 43 of a saw tool. As shown in FIG. 9 (a), the adjustment part 35 of the support 29 has a distance measurement device 1 mounted thereto (via the mount 37), and the position of the adjustment part 35 with respect to the main body 31 has been adjusted so that the distance measuring roller 5 is in contact with an upper surface 49 of a workpiece 51 (e.g. a length of wood to be cut by the saw tool). In views (b) and (c) of FIG. 9 the distance measurement device 1 is not shown, but it can clearly be seen that in each of these views the position of the adjustment part 35 with respect to the main body 31 has been further adjusted to accommodate different sizes of workpiece 51′ and 51″, in particular by moving the adjustment part 35 downwards with respect to the main body 31, to accommodate smaller heights of workpiece, with lower positions of upper surfaces 49′ and 49″, respectively.

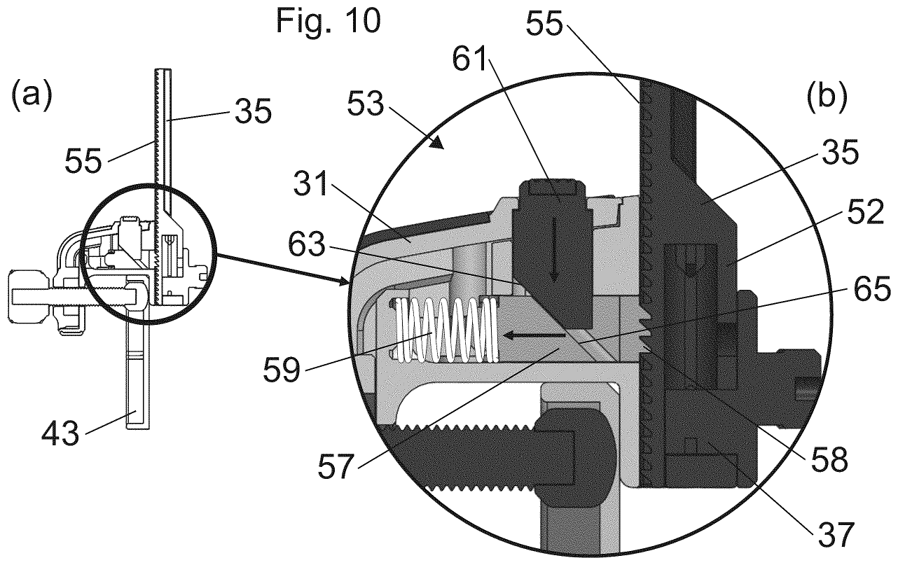

As shown in FIGS. 4 to 9, the adjustment part 35 of the illustrated embodiment is elongate, with the mount 37 located substantially at a longitudinal end region 52 (see FIGS. 9 and 10) of the elongate adjustment part 35. This is so that extension of the adjustment part 35 from the main body 31, so that the mount 37 is spaced from the main body 31, and retraction of the adjustment part 35 towards the main body 31, so that the mount 37 is adjacent to the main body 31, may accommodate a relatively large range of dimensions of workpieces. This is clearly shown in FIG. 9, where the relatively tall workpiece 51 depicted in FIG. 9 (a) and the relatively short (height) workpiece 51″ depicted in FIG. 9 (c) can both be readily accommodated by the support 29 and distance measurement device 1, as can the intermediate height workpiece 51′ depicted in FIG. 9 (b).

As also shown in the sequence of three views (a), (b) and (c) of FIG. 9, the adjustment part 35 of the illustrated embodiment is settable at any of a plurality of positions on the main body 31, to accommodate any of a plurality of different dimensions of workpiece 51 worked on by the tool, in use. The adjustment part 35 may be settable at multiple such positions, and in some embodiments may be settable at twenty or more such positions, e.g. thirty or more such positions. In some embodiments, the adjustment part is settable at substantially any position within a range of positions with respect to the main body, e.g. to accommodate substantially any dimension of workpiece that can be worked on by the tool. That is, in some embodiments, the adjustment part may be “infinitely adjustable” within a predetermined range of positions.

In the embodiment illustrated in the figures, and as shown for example in FIGS. 5, 7 and 10 (and particularly in FIG. 10), the adjustment part 35 is movable with respect to the main body 31 by means of a ratchet mechanism 53. FIG. 10 (a) shows a cross-sectional view of the support 29, and FIG. 10 (b) shows a detail from that view. The ratchet mechanism 53 comprises a series of ratchet teeth 55 arranged on the elongate adjustment part 35 and a movable locking member 57 supported by the main body 31. The locking member 57 has one or more corresponding teeth 58 for locking engagement with one or more ratchet teeth 55 on the adjustment part 35 that are in line with the locking member 57 (depending on the position of the adjustment part 35). Also, the locking member 57 is resiliently biased, e.g. by means of a spring 59 as illustrated (or by means of another type of resilient member, e.g. an elastomeric part), to engage with the ratchet teeth 55 of the adjustment part 35. The illustrated ratchet mechanism 53 also includes a user-actuatable release member 61 on the main body 31, configured to selectively allow substantially free movement of the adjustment part 35 with respect to the main body 31.

Actuation (pressing) of the release member 61 by the user, in the direction of the downward-pointing arrow in FIG. 10 (b), forces the locking member 57 away from the ratchet teeth 55, in the direction of the leftward-pointing arrow in FIG. 10 (b), against the resilient bias of the spring 59, to allow substantially free movement of the adjustment part 35. The user-actuated movement of the release member 61 causes the locking member 57 to move away from the ratchet teeth 55 by means of an interaction between an inclined surface 63 of the release member 61 against an inclined surface 65 of the locking member 57, as indicated by the arrows in FIG. 10 (b). With the release member 61 kept pressed down by the user, the user is able to adjust the position of the adjustment part 35 as required. Once the adjustment part 35 has been placed at the correct position for a particular workpiece, the user releases the release member, thereby allowing the spring 59 (or other resilient member) to return the locking member 57 into locking engagement with the ratchet teeth 55 on the adjustment part 35 that are now in line with it, and also returning the release member 61 to its rest position.

As mentioned above, the mount of the support according to the example embodiment is movable with respect to the main body to adjust a position of the distance measurement device with respect to the main body, in use. As described above, the movement of the mount with respect to the main body may be by means of movement of the adjustment part with respect to the main body, because the adjustment part includes the mount. Additionally (or alternatively, at least in the broadest aspects), the movement of the mount with respect to the main body may be by means of movement of the mount with respect to the adjustment part, and may adjust a position of the distance measurement device with respect to a workpiece on which the tool will be operated, or is being operated, in use. The mount may be resiliently movable with respect to the adjustment part, e.g. to accommodate dimensional variations of a workpiece on which the tool will be operated, or is being operated, in use. Advantageously, a resilient device or member, e.g. a spring, may be located between the mount and the adjustment part, to provide the resilient movability of the mount with respect to the adjustment part. The mount may be configured to be resiliently biased towards a tool to which the support is attached, in use. The arrangement may be such that the mount is configured to be resiliently biased towards a workpiece on which the tool will be operated, or is being operated, in use.

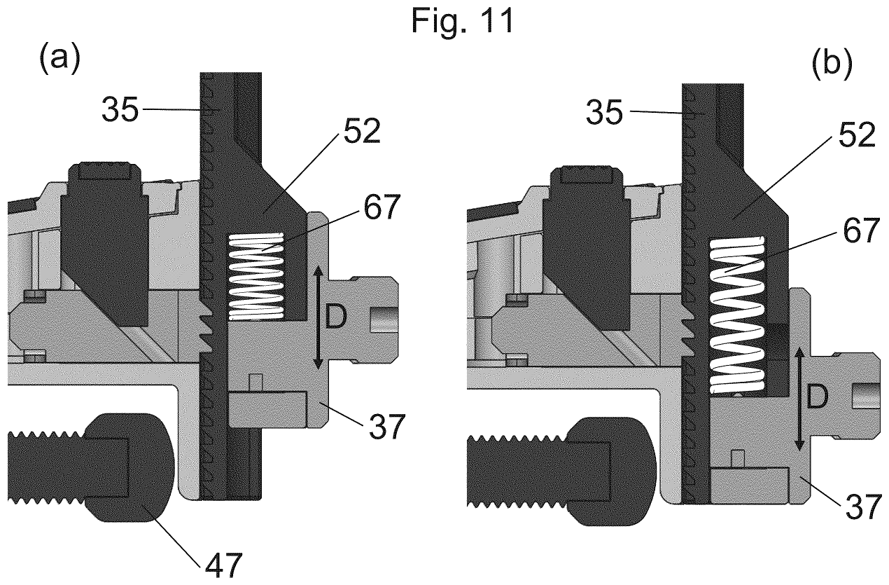

Returning to the description of the illustrated exemplary embodiment, cross-sectional detail views (a) and (b) of FIG. 11 illustrate how the resilient movability of the mount 37 with respect to the adjustment part 35 is achieved in this embodiment. The mount 37 is slidable on the longitudinal end region 52 of the adjustment part 35 and the longitudinal end region 52 of the adjustment part 35 houses a spring 67 (or other resilient part, e.g. an elastomeric member) which resiliently biases the mount 37 in a direction towards the tool, and towards the workpiece, in use (downwards, as illustrated). This resilient biasing of the mount 37 towards the workpiece is arranged to ensure that the distance measuring roller 5 of the distance measuring device 1 mounted to the mount 37 in use remains in consistent contact with the surface of a workpiece being measured. Additionally, the resilient biasing of the mount 37 towards the workpiece is arranged to accommodate any small dimensional variations (e.g. thickness variations) in the workpiece, e.g. along a length of the workpiece. Resilient upward and downward movements of the mount during use are indicated by the double-headed arrows D in FIG. 11 (a) and FIG. 11 (b).

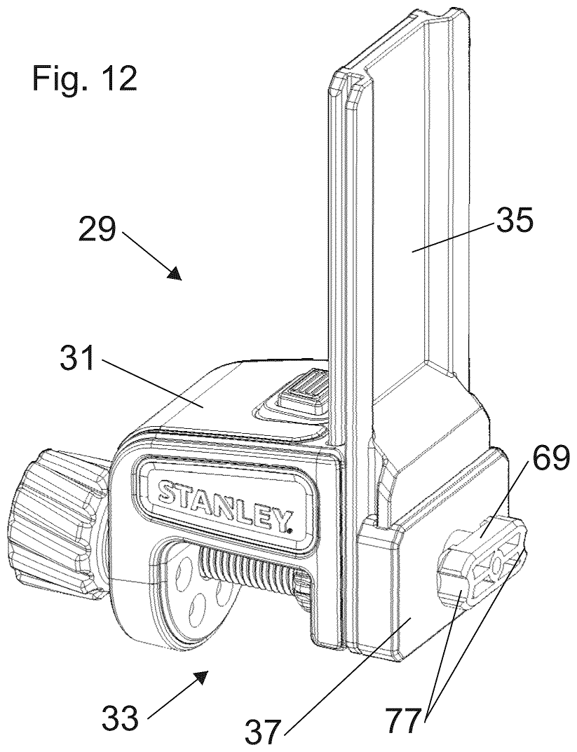

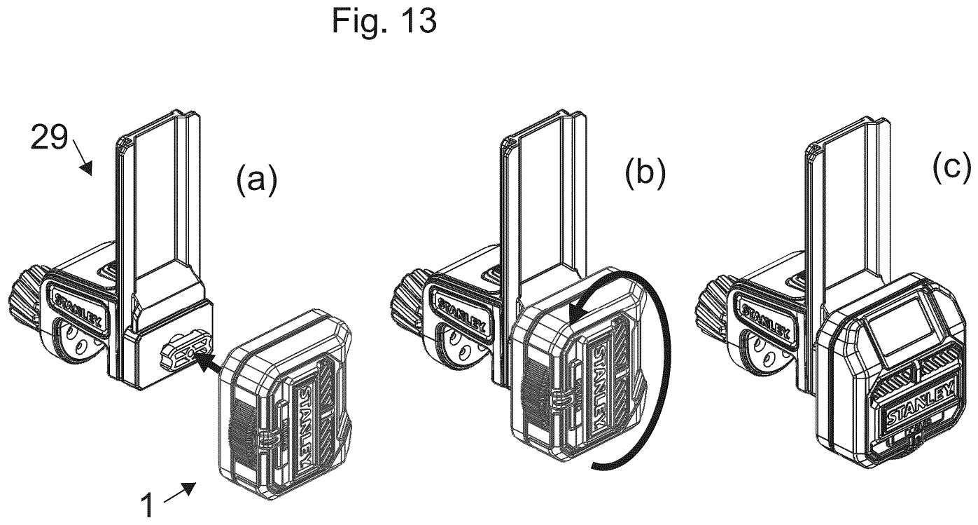

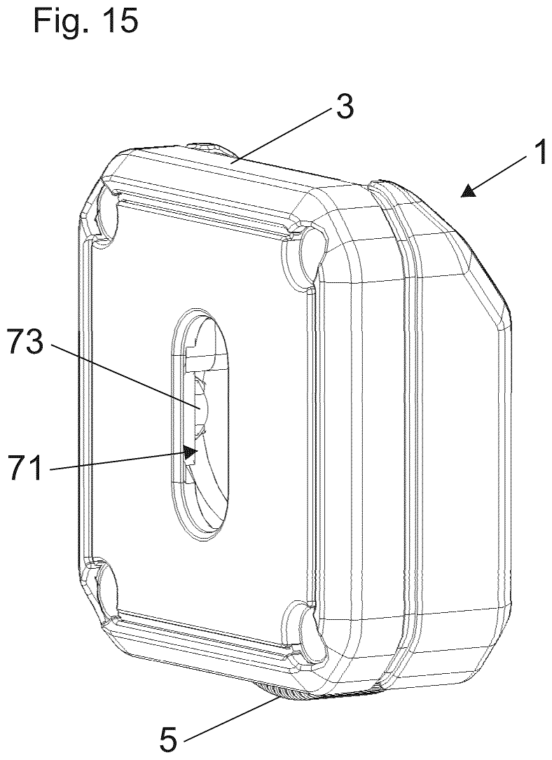

Turning now to FIGS. 12 to 15, for ease and speed of connection and disconnection of the distance measurement device 1, the mount 37 of the support 29 of the illustrated embodiment comprises a male bayonet-fitment connector 69, and a rear face of the housing 3 of the distance measurement device 1 includes a corresponding female bayonet-fitment connector 71. In the illustrated embodiment, the male bayonet-fitment connector 69 of the support 29 has a generally horizontal orientation in use, and the female bayonet-fitment connector 71 of the distance measurement device 1 has a generally vertical orientation in use (but other orientations and configurations are possible, as will be understood by the skilled person, e.g. respective vertical and horizontal orientations, and other orientations). The sequence of views of FIGS. 13 (a), (b) and (c), and the arrows in views (a) and (b) which indicate motion of the distance measurement device relative to the support 29, illustrate the bayonet-fitment (removable) attachment of the distance measurement device 1 to the support 29.

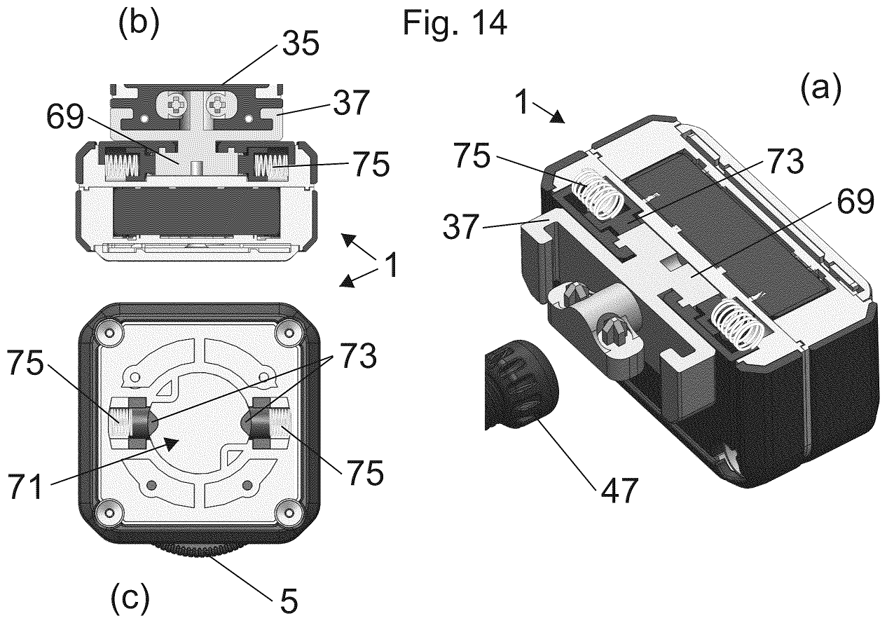

Advantageously, as shown in FIG. 14 views (a), (b) and (c), in the illustrated embodiment of the distance measurement device 1, the female bayonet-fitment connector 71 includes a pair of resiliently-biased detent parts 73 which are biased by springs 75 (or other resilient members, e.g. elastomeric members) to assist in maintaining the connection with the male bayonet-fitment connector 69 of the mount 37 of the support 29 (until disconnection is required), in use. As shown in FIG. 12, the male bayonet-fitment connector 69 of the mount 37 of the support 29 includes a corresponding pair of recesses 77 configured to receive the resiliently-biased detent parts 73.

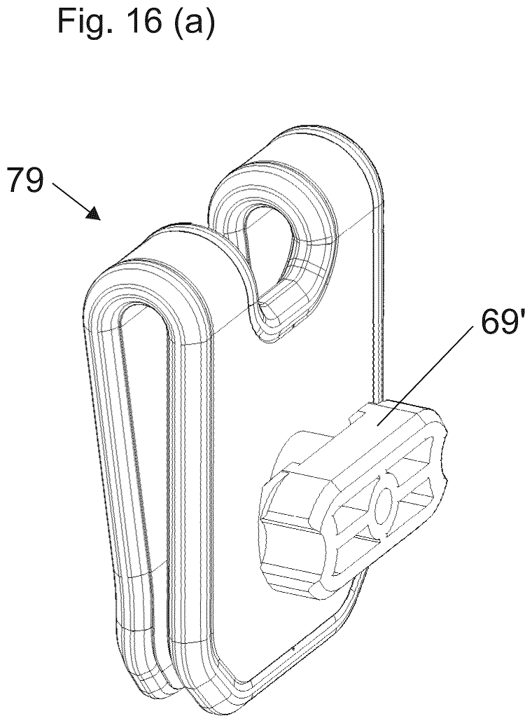

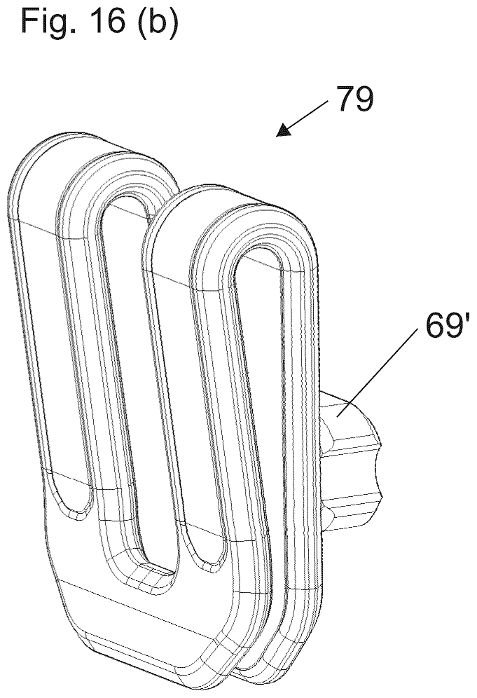

Finally, FIGS. 16 (a) and 16 (b) show a clip 79, that advantageously may be used as a belt clip (or other clip), configured for removable attachment of the distance measurement device 1 to the belt of a user, or to other external objects. As illustrated, the clip 79 includes a male bayonet-fitment connector 69′ which is substantially identical to the male bayonet-fitment connector 69 of the mount 37 of the support 29, for removable attachment of the distance measurement device 1 to the clip 79.

It is to be understood that the described and illustrated embodiments and implementations are examples, and that other embodiments and implementations fall within the scope of the claimed invention.

1. A support, comprising:
a main body comprising an attachment part for removably attaching the support to a tool; and
an adjustment part attached to the main body and comprising a mount for removably mounting a distance measurement device thereto;
wherein the mount is movable with respect to the main body to adjust a position of the distance measurement device with respect to the main body.

2. The support according to claim 1, wherein the adjustment part is movable with respect to the main body to adjust the position of the distance measurement device with respect to the main body.

3. The support according to claim 2, wherein the adjustment part is settable at any of a plurality of positions on the main body.

4. The support according to claim 2, wherein the adjustment part is slidably attached to the main body.

5. The support according to claim 2, wherein the adjustment part is movable with respect to the main body by means of a ratchet mechanism or a rack-and-pinion mechanism.

6. The support according to claim 1, wherein the mount is movable with respect to the main body to adjust a position of the distance measurement device with respect to a workpiece on which the tool is operated.

7. The support according to claim 1, wherein the mount is movable with respect to the adjustment part to adjust a position of the distance measurement device with respect to the main body.

8. The support according to claim 7, wherein the mount is resiliently movable with respect to the adjustment part to accommodate dimensional variations in a workpiece on which the tool will be operated.

9. The support according to claim 1, wherein the attachment part comprises a clamp member.

10. The support according to claim 1, wherein the mount comprises a bayonet-fitment connector.

11. A distance measurement device system comprising:
a support comprising a main body comprising an attachment part for removably attaching the support to a tool; and an adjustment part attached to the main body and comprising a mount; and
a distance measurement device configured for removable mounting to the mount of the support;
wherein the mount is movable with respect to the main body to adjust a position of the distance measurement device with respect to the main body.

12. The distance measurement device system according to claim 11, wherein the mount comprises a first bayonet-fitment connector; and
wherein the distance measurement device comprises a second bayonet-fitment connector configured for removable connection with the first bayonet-fitment connector.

13. The distance measurement device system according to claim 12, wherein at least one of the first bayonet-fitment connector and the second bayonet-fitment connector comprises one or more resiliently-biased detent parts configured to assist in maintaining the connection with the other of the first bayonet-fitment connector and the second bayonet-fitment.

14. The distance measurement device system according to claim 11, wherein the distance measurement device is configured for selective use: (i) mounted to the support; and (ii) as a handheld distance measurement tool disconnected from the support.

15. The distance measurement device system according to claim 11, wherein the distance measurement device comprises: a housing; and a distance measuring roller mounted partly in the housing and extending partly therefrom, and configured for measuring distances along surfaces by rolling contact therewith.

16. The distance measurement device system according to claim 15, wherein the distance measurement device further comprises a display mounted on the housing and configured for displaying distances measured by the roller.

17. A handheld distance measurement tool, comprising:
a housing;
a distance measuring roller mounted partly in the housing and extending partly therefrom, and configured for measuring distances along surfaces by rolling contact therewith;
a display mounted on the housing and configured for displaying distances measured by the roller; and
a bayonet-fitment connector located in and/or on the housing.

18. The handheld distance measurement tool according to claim 17, wherein the bayonet-fitment connector is for removably connecting the handheld distance measurement tool with a separate support having a corresponding bayonet-fitment connector.

19. The handheld distance measurement tool according to claim 18, further comprising the separate support.

20. The handheld distance measurement tool according to claim 19, wherein the separate support comprises a belt clip.
